(19) United States
(12) Patent Application Publication
(10) Pub. No.: US 2019/0160745 A1
(43) Pub. Date: May 30, 2019

(54) CONDUIT TO CARRY COOLING AIRFLOW TO A PRINTHEAD

(71) Applicant: HEWLETT-PACKARD DEVELOPMENT COMPANY, L.P., Houston, TX (US)

(72) Inventors: Ignacio Alejandre, Sant Cugat del Valles (ES); Emilio Carlos Cano, Sant Cugat del Valles (ES); Sergi Culubret, Sant Cugat del Valles (ES)

(21) Appl. No.: 16/092,375

(22) PCT Filed: May 12, 2016
(86) PCT No.: PCT/US2016/032036

§ 371 Date: Oct. 9, 2018

(51) Int. Cl. B29C 64/209; B29C 64/393; B29C 35/16; B29C 64/165; B33Y 30/00; B33Y 40/00; B33Y 50/02

(52) U.S. Cl. CPC B29C 64/209; B29C 64/393; B29C 35/16; B29C 64/165; B29C 2035/1683; B33Y 40/00; B33Y 50/02; B29C 2035/1666; B33Y 30/00

(57) ABSTRACT

In some examples, a carriage for a printing system includes a printhead, a conduit to carry a cooling airflow to the printhead, a return chamber to receive a heated exhaust airflow produced from heating of the cooling airflow by the printhead, and a seal between the printhead and the return chamber to prevent the heated airflow from flowing to a location below the printhead.

### BACKGROUND

A printing system can include a printhead for delivering an agent, such as a liquid agent or other substance, to a target. In some examples, a printhead can be used in a three-dimensional (3D) printing system, which is able to form 3D objects. A 3D printing system performs a 3D printing process, which is also referred to as an additive manufacturing (AM) process, in which successive layers of material(s) of a 3D object are formed under control of a computer based on the 3D model or other electronic representation of the object. The layers of the object are successively formed until the entire 3D object is formed.

### BRIEF DESCRIPTION OF THE DRAWINGS

Some implementations of the present disclosure are described with respect to the following figures.

FIG. 1 is a block diagram of a portion of a printing system according to some examples.

FIG. 2 is a perspective view of an assembly that includes an active cooling subsystem and printheads that are being cooled by the active cooling subsystem, according to some examples.

FIG. 3 is a cross-sectional view of a portion of the assembly depicted in FIG. 2, according to some examples.

FIG. 4 is a simplified block diagram of a portion of a printing system according to some examples.

FIG. 5 is a front view of an assembly that includes an active cooling subsystem and a printhead being cooled by the active cooling subsystem, according to further examples.

FIG. 6 is a block diagram of a portion of a printing system including a controller to perform feedback control of an airflow generator, according to some examples.

FIG. 7 is a flow diagram of a process of forming a carriage for a printing system, according to some examples.

### DETAILED DESCRIPTION

In the ensuing discussion, reference is made to a cooling solution for a printhead of a three-dimensional (3D) printing system. In alternative examples, cooling solutions according to some implementations can also be used to cool printheads for two-dimensional (2D) printing, in which the printhead can be used to print text or images onto a flat print medium such as a paper substrate or other type of substrate.

In a 3D printing system, a build material (or multiple different build materials) can be used to form a 3D object, by depositing the build material(s) as successive layers until the final 3D object is formed. A build material can include a powdered build material that is composed of particles in the form of fine powder or granules. The powdered build material can include metal particles, plastic particles, polymer particles, or particles of other materials.

As layers of build material(s) are formed on the surface of the build platform, a printhead can be used to deliver an agent (or agents) to the successive layers of the build material(s). The agent can be a liquid agent or a different substance. In some examples, an agent can be delivered to portions of a layer of powdered build material to fuse, or assist in fusing, the portions of the layer of build material, to define edges or shapes of the portions of the layer of build material, and/or for other purposes.

In a 2D printing system, a printhead can be used to deliver ink or other printing liquid to print text or images on a print medium. This print medium can be provided on a support platform of the printing system.

Generally, the term “print platform” as used herein can refer to the build platform of a 3D printing system, or to a support platform of a 2D printing system.

A “printhead” can refer to a component or an assembly of components in a printing system that is used to deliver an agent, such as a liquid agent, to a target. During a printing operation, the temperature of the printhead can rise substantially. The heating of the printhead can be caused by heating elements, such as in the form of resistors, included in the printhead that is used for heating a liquid agent prior to emission of the liquid agent from nozzles of the printhead.

In addition, in a 3D printing system, a layer of build material provided on the build platform of the printing system may be heated to a relatively high temperature. As a result, a print chamber in which the build platform is provided can become quite hot, and as a result, a printhead can also be subjected to heating from the hot printing chamber or other elements. For some build materials, the build platform can reach a temperature of up to about 165° C., so that the printing chamber can reach a temperature of up to about 100° C., with a vertical temperature stratification present (where a lower part of the printing chamber can have a lower temperature than a higher part of the printing chamber). Although specific example temperature values are given, it is noted that the printing chamber can reach other temperatures in other examples.

A printhead can include various electronic elements, such as an integrated circuit device that controls heating in the printhead and emission of an agent from nozzles of the printhead. Such electronic elements may be damaged if the temperature of the printhead is elevated too high.

In accordance with some implementations of the present disclosure, an active cooling subsystem is provided in a printing system to provide cooling airflows to cool a printhead. In the ensuing discussion, reference to a “printhead” can be a reference to a single printhead or multiple printheads of the printing system. An “airflow” can refer to a flow of a gas, such as air or another type of gas (e.g. an inert gas).

The active cooling subsystem is attached to or is part of a carriage of the printing system. The active cooling subsystem includes an airflow generator and a tubular conduit to transport a cooling airflow generated by the airflow generator to the printhead. The tubular conduit can include a tube or multiple tubes that can carry the cooling airflow directly to the body of the printhead. A seal can be provided around the printhead to prevent airflow from flowing past the carriage, so as not to disturb a target (e.g. a layer of powdered build material) on a print platform of the printing system.

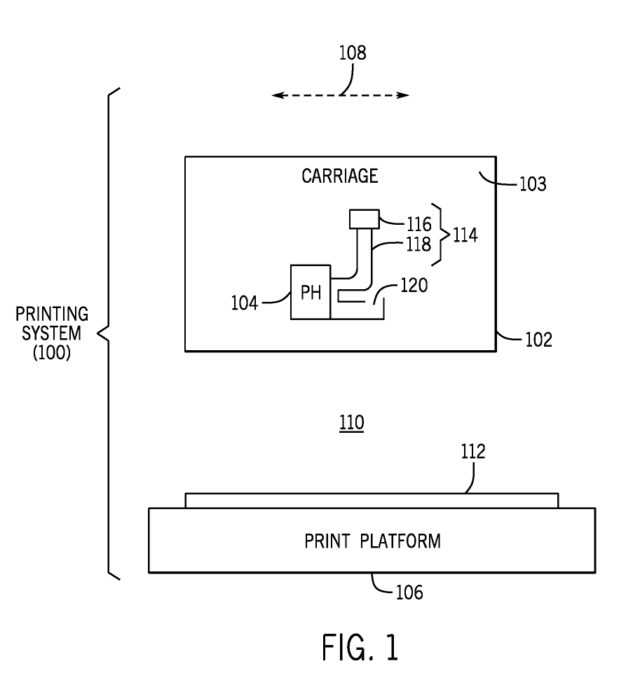

FIG. 1 is a block diagram of an example printing system 100 that includes a carriage 102 that carries a printhead 104 according to some examples. A “carriage” can refer to a structure that is used for carrying components, including the printhead 104, as well as other components such as a heating lamp assembly to produce heat, a sensor to sense a respective parameter, and so forth. The printing system 100 can be a 2D printing system or a 3D printing system.

The printing system 100 also includes a print platform 106. The carriage 102 and the print platform 104 are movable with respect to each other. In some examples, the print platform 106 is stationary while the carriage 102 can be moved along an axis 108. In other examples, the carriage 102 can be stationary while the print platform 106 is moved relative to the printhead 102 along the axis 108. In further examples, both the carriage 102 and the print platform 106 can be moved along the axis 108. Note further that it is possible for the carriage 102 and the print platform 104 to be movable relative to each other along multiple different axes. The relative motion of the carriage 102 and the print platform 164 can be driven by a motor (or multiple motors), not shown.

The relative motion of the carriage 102 and the print platform 104 can cause the printhead 104 to be at different positions. While the printhead 104 is above the print platform 106, the printhead 104 is in an active region 110. While the printhead 104 is above the active region 110, the printhead 104 can be activated to deliver an agent towards a target 112 on the upper surface of the print platform 106.

In some examples, if the print platform 106 is a build platform of a 3D printing system, then the target 112 can be a layer of powdered build material onto which an agent can be delivered by the printhead 104. In other examples, if the print platform 106 is a support platform of a 2D printing system, then the target 112 is a print medium onto which ink can be delivered by the printhead 104.

In the ensuing discussion, reference is made to movement of the carriage 102 relative to the print platform 106. Note, however, that techniques or mechanisms according to some implementations can be applied to other arrangements in which the carriage 102 is stationary but the print platform 106 is moveable, or to arrangements in which both the carriage 102 and the print platform 106 are moveable.

During a print operation, in which the printhead 104 can be moved back and forth many times over the print platform 106 (such as to process successive layers of build material formed on the print platform 106), the printhead 104 can be heated due to activation of heating elements in the printhead 104 that are used for heating an agent prior to emission of the agent from the printhead 104, such as from nozzles of the printhead 104. In addition, in a 3D printing system, the layer of build material (112) can also be heated, which causes the active region 110 above the print platform 106 to be heated to cause heating of the printhead 104.

The printhead 104 can include electronic elements (e.g. an integrated circuit device or other electronic elements), which can control heating and delivery of an agent through the nozzles of the printhead 104. Such electronic elements of the printhead 104 can be damaged if the temperature of the printhead 104 rises above a temperature threshold.

To cool the printhead 104, an active cooling subsystem 114 including an airflow generator 116 and a tubular conduit 118 can be provided. The active cooling subsystem 114 can be carried by the carriage 102 along with the printhead 104. Thus, the active cooling subsystem 114 is attached to the carriage 102, or can be considered to be part of the carriage 102.

The airflow generator 116 can include a fan or multiple fans. The airflow generator 116 is able to generate a cooling airflow that can be passed through the tubular conduit 118 to cause the cooling airflow to be directed to a body of the printhead 104, such as to a surface (or multiple surfaces) of the printhead 104. A pipe (or pipes) used to form the tubular conduit 118 can include an inner bore surrounded by an outer housing. The cooling airflow can pass through the inner bore of the pipe(s). A pipe can have a circular cross section, a rectangular cross section, or a cross section of a different shape. In different examples, the air flow generator can be a connection to a compressed air system or other mechanism to provide sufficient flow and pressure.

The cooling airflow heated by the printhead 104 is output as heated exhaust airflow through an exhaust opening 120 away from the active region 110, so as not to disturb the target 112 on the print platform 106.

The printhead 104 can be cooled by the active cooling subsystem 114 during an active print operation, since the cooling airflow and the heated exhaust airflow do not disturb the target 112 and would not affect the trajectory of an agent emitted by the printhead 104. In this way, the printhead 104 can be kept at a temperature that is below a target temperature threshold above which damage to the printhead 104 may occur. More specifically, the temperature of the printhead 104 can be kept within a specified range so that damage to the printhead 104 does not occur, and the printhead 104 can operate according to a target specification.

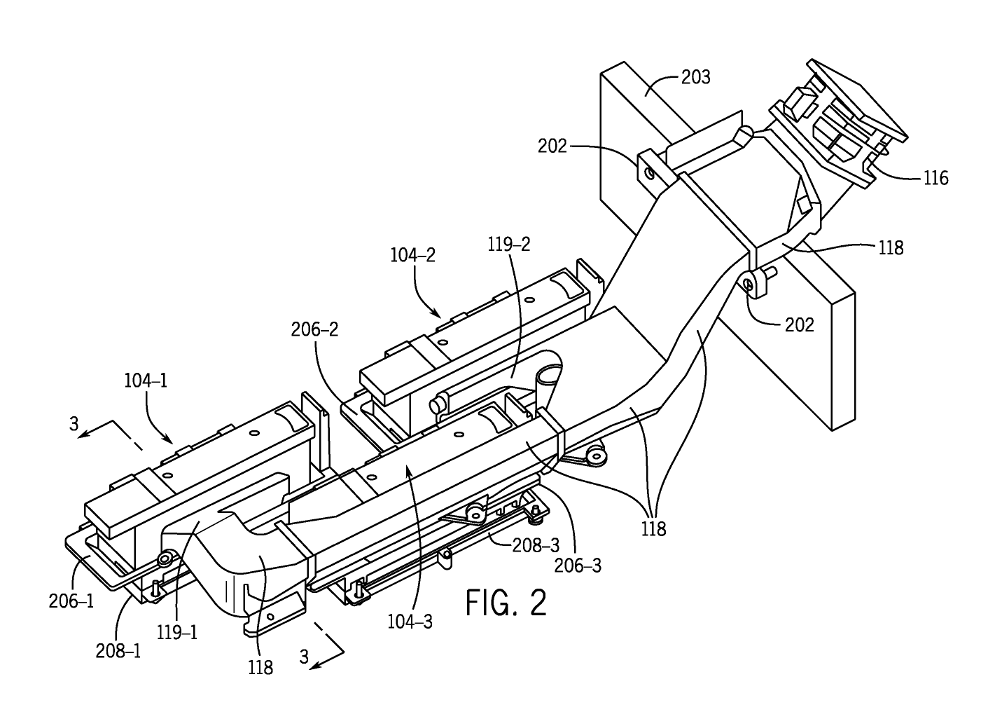

FIG. 2 is a perspective view of the active cooling subsystem 114 (FIG. 1) according to some examples that can be used to deliver cooling airflow to multiple printheads 104-1, 104-2, and 104-3. in examples according to FIG. 2. Although three printheads 104-1, 104-2, and 104-3 are shown in FIG. 2, it is noted that in other examples, a different number (one or greater than two) of printheads may be cooled by the active cooling subsystem 114.

As can be seen in FIG. 2, the tubular conduit 118 can be formed of multiple discrete pipe sections that are attached together. In other examples, the tubular conduit 118 can be formed using a single integral pipe. FIG. 2 also shows an attachment mechanism 202 of the active cooling subsystem 114, where the attachment mechanism 202 is used to attach the active cooling subsystem 114 to a support structure 203 of the carriage 102. In examples according to FIG. 2, the attachment mechanism 202 includes flange members with through holes to allow for respective screws to pass through to attach the active cooling subsystem 114 to the support structure 203 of the carriage 102. In other examples, the attachment mechanism 202 can include a different type of attachment for active cooling subsystem 114 to the support structure 203.

Respective end portions 119-1 and 119-2 of the tubular conduit 118 are arranged to be adjacent the respective printheads 104-1 and 104-2. More specifically, in some examples, the end portions 119-1 and 119-2 can be in contact with the bodies of the respective printheads 104-1 and 104-2, such that the cooling airflow transported by the tubular conduit 118 can be provided in a different way (than blowing cooling airflow to the printheads without passing the cooling airflow through the tubular conduit 118) to the printheads 104-1 and 104-2. A portion of the tubular conduit 118 can also be arranged to be adjacent the printhead 104-3, to transport cooling airflow to the printhead 104-3.

As further shown in FIG. 2, printhead mounting structures 206-1, 206-2, and 206-3 of the carriage 102 are used to mount the respective printheads 104-1, 104-2, and 104-3 in the carriage 102. The printhead mounting structures 206-1, 206-2, and 206-3 can define corresponding receptacles to receive the respective printheads 104-1 and 104-2. Further support structures 208-1 and 208-3 can be attached to the printhead mounting structures 206-1 and 206-3, respectively. The further support structure for the printhead mounting structure 208-2 is not visible in the view of FIG. 2.

In addition, the carriage 102 further includes a conduit mounting structure (not shown) for mounting a portion of the tubular conduit 118. The tubular conduit 118 can be attached to the conduit mounting structure using a fastener, such as a screw or any other type of attachment element.

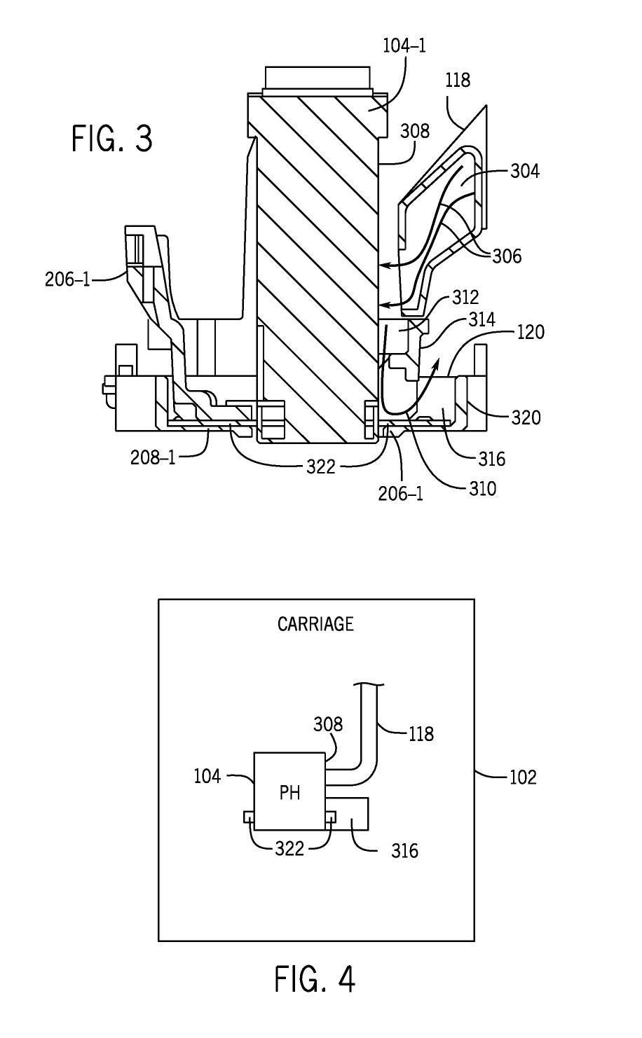

A cross-sectional view of a portion of the assembly shown in FIG. 2 along section line 3-3 is depicted in FIG. 3. The printhead 104-1 in FIG. 3 is mounted to the mounting structure 206-1 of the carriage 102. An end portion of the tubular conduit 118 of the active cooling subsystem 114 is also shown in FIG. 3. An end piece of the tubular conduit 118 has been cut away in the view of FIG. 3, to allow an inner bore 304 the tubular conduit 118 to be visible in the view of FIG. 3. In an actual implementation, the end piece of the tubular conduit 118 can be in contact with a side surface 308 of the printhead 104-1, as depicted in FIG. 2. A cooling airflow 306 flows through the inner bore 304 of the tubular conduit 118 and impacts the side surface 308 of the printhead 104-1. The cooling performed by the active cooling subsystem 114 does not interfere with the printhead nozzles, and thus can be used during a printing operation.

In alternative examples, the tubular conduit 118 can be used to deliver the cooling airflow to multiple surfaces of the printhead 104-1, instead of just to the side surface 308 of the printhead 104-1. A heated exhaust airflow produced by heating the cooling airflow 306 by the printhead 104-1 is passed through a channel 312 that is defined between the side surface 308 of the printhead 104-1 and a wall 314 that is part of the mounting structure 206-1 of the carriage 102. The heated exhaust airflow 310 flows through the channel 312 to a return chamber 316 that is confined between the side surface 308 of the printhead 104-1 and a bracket 320 of the mounting structure 206-1. The heated exhaust airflow 310 continues through the return chamber 116 through an exhaust opening 120 defined between the wall 314 and the bracket 320.

The heated exhaust airflow 310 continues through the exhaust opening 120 to cause the heated exhaust airflow 310 to be directed generally upwardly, away from the active region 110 that is underneath the printhead 104-1 in the orientation shown in FIG. 3. In addition, as shown in FIG. 3, a seal 322 is provided between the outer surface of the printhead 104-1 and the mounting structure 206-1 of the carriage 102. The seal 322 can be an O-ring seal or a rubber or foam film, for example, that is provided around the outer surface of the printhead 104-1. The seal 322 can be formed of a compressible material, such as elastomer or other pliable material, to provide an air seal to block the heated exhaust airflow 310 from leaking through a passage between the outer surface of the printhead 104-1 and the mounting structure 206-1 past the carriage to the active region 110. The presence of the seal 322 prevents the heated airflow from flowing to a location below the printhead 104-1 or below the carriage 102 (FIG. 1). If the seal 322 were not present, the leaked heated exhaust airflow may exit to the active region 110 (FIG. 1) below the printhead 104-1 and below the carriage at a relatively high rate, which may cause a disturbance of the target 112 (e.g. the layer of powdered build material 112) on the print platform 106. By using the arrangement shown in FIG. 3, cooling airflow 306 can be passed over the printhead 104-1 surface to cool the printhead 104-1, and the heated exhaust airflow 310 can be directed away from the active region 110 such that the target 112 is not disturbed by the airflow.

Airflow reaching the active region 110 in a 3D printing system at high rates can disturb a powdered build material layer to cause particles of the powdered build material to disperse due to the airflow. The dispersed particles of the powdered build material can be blown towards a printhead and other components of a carriage (not shown) of the printing system, where such other components can include a heating lamp assembly, a sensor, and so forth. The dispersed powders may be ingested through the nozzles of the printhead to cause clogging, or can coat surfaces of other components to reduce the performance of such other components, or can produce defects on the printed part. Moreover, powders of the powdered build material that come into contact with a hot surface, such as that of a heating lamp assembly, can cause the powders to ignite, which can damage the printing system 100 or cause a safety hazard to humans.

FIG. 4 is a simplified view of the carriage 102 for a printing system according to some examples. The carriage 102 includes the printhead 104, the tubular conduit 118, and the return chamber 316. The tubular conduit 118 carries cooling airflow to the side surface 308 of the printhead 104. Heated exhaust airflow produced from heating the cooling airflow by the printhead 104 is received in a return chamber 316, to allow the heated exhaust airflow to exit the return chamber 316 in a direction that is generally away from the active region 110 (FIG. 1).

As further shown in FIG. 4, the seal 322 is provided around the outer surface of the printhead 104 between the printhead and a mounting structure of the carriage 102, to prevent airflow that impacts the printhead 104 from leaking into the active region 110.

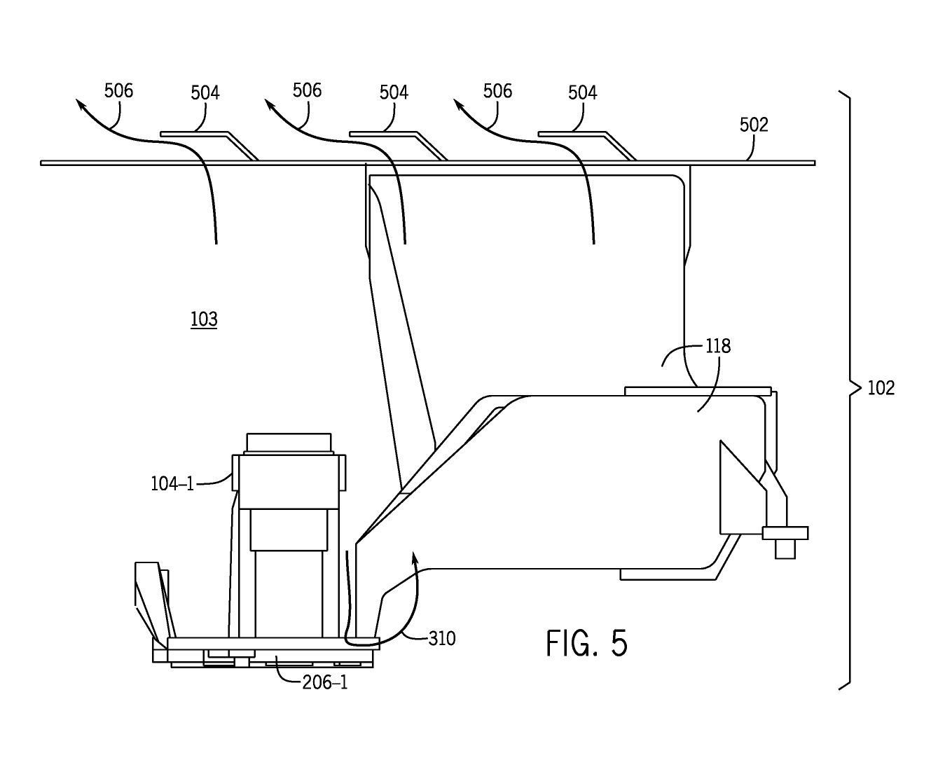

FIG. 5 is a front view of a portion of the carriage 102 that includes the tubular conduit 118 and the printhead 104-1 that is carried by the mounting structure 302 of the carriage 102. FIG. 5 shows the heated exhaust airflow 310 after it has exited through the exhaust opening 120 of the return chamber 316 shown in FIG. 3.

The carriage 102 has an upper cover 502, where the cover 502 has outlets 504 to allow the heated exhaust airflow 310 to escape (along paths 506) from the inner space 103 of the carriage 102. The outlets 504 can be in the form of openings in the cover 502, where the openings can act as chimneys to allow the heated airflow 310 to escape from the carriage 102 towards a space that is outside the carriage 502.

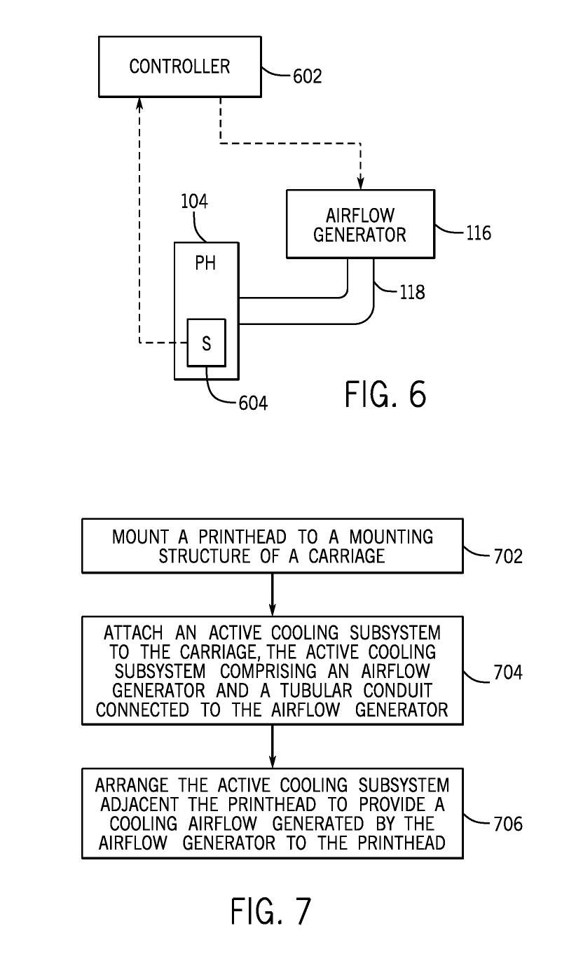

FIG. 6 is a block diagram of a portion of a printing system according to further examples. The printing system includes a controller 602, which can be implemented as a microprocessor, a core of a multi-core microprocessor, a microcontroller, a programmable integrated circuit device, a programmable gate array, or another hardware processing circuit. The controller 502 can also in some examples include machine-readable instructions executable on the hardware processing circuit.

The controller 602 can be used to perform feedback control on the airflow generator 116 based on a temperature measurement received from a temperature sensor 604 that can be part of the printhead 104. The temperature sensor 604 measures a temperature of the printhead 104, and provides the measured temperature to the controller 602. Based on the received measured temperature, the controller 602 can provide a control signal to the airflow generator 116 to adjust the airflow generator 116. For example, the controller 602 can activate or deactivate the airflow generator 116 in response to the temperature measurement. Moreover, the controller 602 can control the rate of cooling airflow produced by the airflow generator 116. For example, the controller 602 can control the rotational speed of a fan of the airflow generator 116. In response to the measured temperature from the temperature sensor 604 being at a higher level, the controller 602 can instruct the airflow generator 116 to increase its speed to produce a cooling airflow at a higher rate. On the other hand, if the measured temperature from the temperature sensor 604 indicates that the temperature of the printhead 104 is at a lower level, then the controller 602 can instruct the airflow generator 116 to reduce its speed to reduce the cooling airflow rate. Moreover, if the measured temperature from the temperature sensor 604 is sufficiently low (e.g. lower than a specified threshold), the controller 602 can instruct the airflow generator 116 to turn off.

By being able to reduce the speed of the airflow generator 116 or even deactivate the airflow generator 116, the speed of the airflow generator 116 can be kept as low as possible to reduce noise and reduce power consumption. Also, the feedback control of the airflow generator 116 allows the temperature of the printhead 104 to be maintained within a specified temperature range. This temperature range can ensure that the printhead 104 does not overheat, so that damage to the electronic components of the printhead 104 does not occur. Also, the temperature range can be maintained such that the sizes of droplets of an agent can be kept to a target size.

FIG. 7 is a flow diagram of a process of forming a carriage for a printing system, according to some implementations. The process includes mounting (at 702) a printhead to a mounting structure of the carriage. The process further includes attaching (at 704) an active cooling subsystem to the carriage, the active cooling subsystem comprising an airflow generator and a tubular conduit connected to the airflow generator. The process further includes arranging (at 706) the active cooling subsystem adjacent the printhead to provide a cooling airflow generated by the airflow generator to the printhead

Machine-readable instructions executable on the controller 602 of FIG. 6 can be stored in a non-transitory computer-readable or machine-readable storage medium. The storage medium can include one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A carriage for a printing system, comprising:
a printhead;
a conduit to carry a cooling airflow to the printhead;
a return chamber to receive a heated exhaust airflow produced from heating of the cooling airflow by the printhead; and
a seal between the printhead and the return chamber to prevent the heated airflow from flowing to a location below the printhead.

2. The carriage of claim 1, wherein the conduit comprises a tube.

3. The carriage of claim 1, wherein the conduit and return chamber are provided within an inner space of the carriage.

4. The carriage of claim 1, further comprising another printhead, wherein the conduit is to carry the cooling airflow further to the another printhead.

5. The carriage of claim 1, wherein the return chamber has an exit opening to direct the heated exhaust airflow away from a print platform of the printing system to avoid disturbing a target on the print platform.

6. The carriage of claim 5, further comprising a cover comprising an opening, wherein the heated exhaust airflow is to rise towards the cover to exit through the opening.

7. The carriage of claim 1, further comprising an airflow generator connected to the conduit.

8. The carriage of claim 7, further comprising a temperature sensor to communicate a temperature measurement to a controller of the printing system to cause feedback control of the airflow generator.

9. A printing system comprising:
a carriage that is moveable with respect to a print platform of the printing system;
a printhead carried by the carriage to deliver an agent to a target on the print platform; and
an active cooling subsystem attached to the carriage and comprising:
an airflow generator;
a tubular conduit connected to the airflow generator and in contact with the printhead, the tubular conduit to transport a cooling airflow produced by the airflow generator to the printhead; and
an exhaust opening through which a heated exhaust airflow is to flow away from the print platform.

10. The printing system of claim 9, further comprising another printhead carried by the carriage, and wherein the tubular conduit is in contact with the another printhead to transport the cooling airflow to the another printhead.

11. The printing system of claim 9, further comprising a seal between a mounting structure of the carriage and the printhead to block the heated exhaust airflow from flowing past the carriage towards the print platform.

12. The printing system of claim 11, wherein the tubular conduit is to carry the cooling airflow to a side surface of the printhead, the carriage further comprising a channel to transport the heated exhaust airflow to a return chamber that includes the exhaust opening.

13. The printing system of claim 12, wherein the carriage comprises a cover including an opening, and wherein the heated exhaust airflow is to rise in an inner space of the carriage to exit through the opening of the cover.

14. The printing system of claim 9, wherein the printhead comprises a temperature sensor, the printing system further comprising a controller to adjust the airflow generator in response to a temperature measurement from the temperature sensor.

15. A method of forming a carriage for a printing system, comprising:
mounting a printhead to a mounting structure of the carriage;
attaching an active cooling subsystem to the carriage, the active cooling subsystem comprising an airflow generator and a tubular conduit connected to the airflow generator; and
arranging the active cooling subsystem adjacent the printhead to provide a cooling airflow generated by the airflow generator through the tubular conduit to the printhead.
